(19) United States
(12) Patent Application Publication
(10) Pub. No.: US 2008/0211645 A1
(43) Pub. Date: Sep. 4, 2008

(54) WARNING SYSTEM FOR A MOTOR VEHICLE

(75) Inventor: Joachim Mathes, Heilbronn (DE)

Correspondence Address: BRINKS HOFER GILSON & LIONE, P.O. BOX 10395, CHICAGO, IL, 60610, US

(73) Assignee: Valeo Schalter und Sensoren GmbH, Bietigheim-Bissingen (DE)

(21) Appl. No.: 12/119,188

(22) Filed: May 12, 2008

Related U.S. Application Data
(63) Continuation of application No. PCT/EP2006/009210, filed on Sep. 22, 2006.

(30) Foreign Application Priority Data
Nov. 30, 2005 (DE) 10 2005 058 130.7

(51) Int. Cl. B60Q 1/00

(52) U.S. Cl. 340/435

(57) ABSTRACT

The invention relates to a warning system for a motor vehicle, having a sensor system for sensing the position of the motor vehicle relative to a carriageway delimitation which is marked on a carriageway, and having an evaluation unit which is coupled to the sensor system, the evaluation unit being connected to at least one output unit and/or to at least one actuator for outputting warning signals to the driver, warning signals of different types and/or intensities being assigned to different positions of the motor vehicle relative to a carriageway delimitation.

### CROSS-REFERENCE TO RELATED APPLICATIONS

This application is a continuation of International Application No. PCT/EP2006/009210 filed on Sep. 22, 2006, which claims the benefit of DE 10 2005 058 130.7, filed Nov. 30, 2005. The disclosures of the above applications are incorporated herein by reference.

### FIELD

The invention relates to a warning system, and more particularly, to a warning system for a motor vehicle.

### BACKGROUND

The statements in this section merely provide background information related to the present disclosure and may not constitute prior art.

Warning systems are commonly known from vehicles by the Citroen Company, for example. These systems serve to warn the driver of a motor vehicle when he crosses a highway delimitation. An unintentional crossing of highway delimitations, in other words, the unintentional changing of a lane, can occur when the driver of a motor vehicle is distracted or tired. The warning system emits a warning signal upon crossing such a highway delimitation, which signals to the driver that he is leaving his lane.

There are situations when, even for a very alert driver, it is difficult to maintain the vehicle within a lane. This can be the case for comparatively wide vehicles which are being driven on a very narrow lane, such as within highway construction sites. Another example is turning lanes within an intersection, which are positioned parallel to one another. During such situations, it may be upsetting to a driver when a warning signal is triggered too often. For this particular reason, the familiar warning systems may be turned off by the driver, and such warning systems then have little use.

### SUMMARY

The present disclosure provides an improved warning system for a motor vehicle that provides a more comfortable process for the driver in the operational condition thereof.

The warning system includes a sensor system for sensing the position of the motor vehicle relative to a highway delimitation which is marked on a highway. The warning system has an evaluation unit that is connected to at least one output unit and/or to at least one actuator for outputting warning signals to the driver.

Warning signals of different types and/or intensities are assigned to different motor vehicle positions relative to a highway delimitation. This makes it possible to provide the driver with not just any warning signal that indicates an unintended lane change, but the warning signals can be adjusted to different traffic situations. This increases the acceptance of the system and therefore the anticipated usage period.

Due to the adjustment of the warning signals to the different positions of the motor vehicle relative to a highway delimitation, it is possible to avoid a warning signal having an intensity that is too strong or too low. If—as is known from the state of the art—only one warning signal is available, it should be designed such that when in doubt it is capable of refocusing the driver even if he has nodded off momentarily. Such a warning signal must be relatively strong so that the driver of a motor vehicle would, in most traffic situations, perceive it as highly intensive and therefore as annoying.

The adjustment of the warning signals with respect to their type and/or intensities is designed to prevent these problems.

In one form, the relative positions to be sensed include at least one relative position in which at least one wheel of the motor vehicle completely crosses the highway delimitation. This relative position thus describes the condition in which at least one wheel of the motor vehicle is already positioned on a neighboring lane or, after crossing a highway delimitation, is already positioned on the highway verge. This condition is appropriately assigned a comparatively obvious and/or intensive warning signal.

In some forms, the relative positions to be sensed include at least one relative position in which at least one wheel of the motor vehicle covers the highway delimitation at least in sections. Since the motor vehicle in such a traffic situation protrudes less significantly into a neighboring lane or into the marginal area of a highway delimitation, it is practical to assign a less intensive warning signal to this relative position, so that the driver does not perceive these warning signals as annoying.

In some forms, the sensor system and the evaluation unit are designed to determine the degree of overlap for the wheel and the highway delimitation. This allows the determination of additional positions, starting with one wheel of the motor vehicle wheel slightly touching the highway delimitation up to complete overlap. Warning signals of different types and/or intensities can then be assigned to different relative positions.

In one form, the assignment of different relative positions to warning signals of different intensities is proportional. Such proportionality can, for example, be achieved by means of proportionately increasing the volume.

A relative position in which one wheel of a motor vehicle covers the highway delimitation at least in sections may be assigned a warning signal of a first type, and a relative position in which at least one wheel of a motor vehicle completely crosses the highway delimitation may be assigned a warning signal of a second type. A warning signal of the first type can, for example, include acoustical signals, which can for example be emitted through a speaker, while the warning signals of the second type can include haptic signals, which can be communicated to the driver by means of vibrations in portions of the seat and/or the steering wheel. Each relative position can be simultaneously assigned warning signals of different types, for example, acoustical and optical warning signals to a first relative position and acoustical and haptic warning signals to a second relative position.

The assignment of different types of warning signals may also be used for relative positions in which one wheel of the motor vehicle covers the highway delimitation with different degrees of overlap.

The disclosure also relates to a method for the operation of a warning system. In one aspect, the intensity of a warning signal is diminished or the output of the warning signal is terminated if at least one predetermined reference condition is achieved. Such a reference condition may be achieved if at least one wheel of the motor vehicle has completely crossed the highway delimitation. Such a reference condition can also be achieved if the condition corresponds to the complete crossing of the highway delimitation of all wheels of the motor vehicle. In such a case, it can be presumed that the lane change was intentional and the emission of warning signals is no longer necessary.

The reference condition can also correspond to the lapse of a certain time limit. The signals can thus be diminished or terminated after a certain period in order to not expose the driver too long to the warning signals.

The reference condition can also correspond to a minimum traveled distance. If, for example, the motor vehicle has traveled a certain distance in a neighboring lane, even though warning signals have been emitted, it can be presumed that the partial or complete lane change was intentional.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic plan view of a motor vehicle which is positioned on a highway with highway delimitations;

FIG. 2 is a schematic front view of a minimal degree of overlap of a wheel of the motor vehicle of FIG. 1 with a highway delimitation;

FIG. 3 is a is schematic front view of a maximum degree of overlap of a wheel of the motor vehicle of FIG. 1 with a highway delimitation; and

FIG. 4 is a graph illustrating the assignment of different relative positions of the motor vehicle and highway delimitations versus intensity of a warning signal.

### DETAILED DESCRIPTION

The following description is merely exemplary in nature and is not intended to limit the present disclosure, application, or uses.

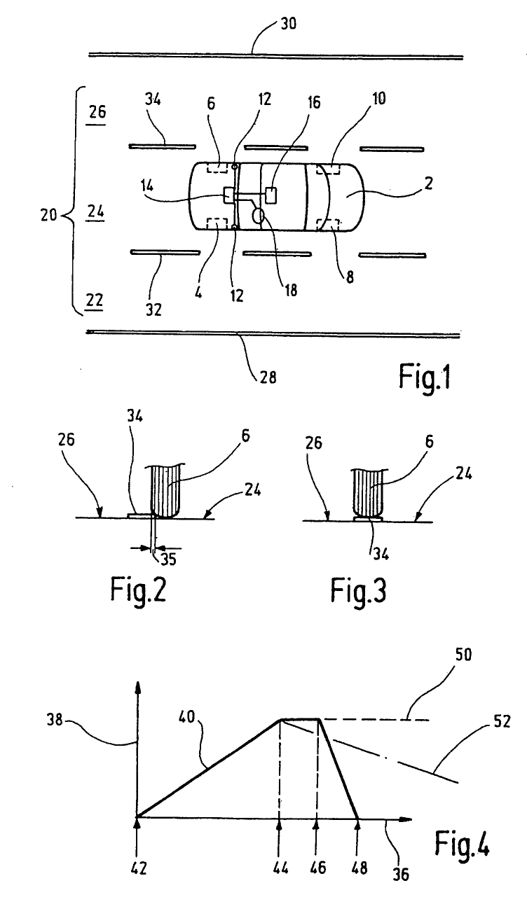

FIG. 1 shows a schematic illustration of a motor vehicle that is marked with the reference numeral 2. The motor vehicle 2 has a left front wheel 4, a right front wheel 6, a left rear wheel 8, as well as a right rear wheel 10. The motor vehicle 2 is furthermore equipped with a sensor system 12, which makes it possible to sense the position of motor vehicle 2 relative to the highway delimitations. The sensor system may use infrared sensors, by way of example.

The sensor system 12 is connected to an evaluation unit 14, which evaluates the signals acquired by the sensor system 12. The evaluation unit 14 is connected to an output unit 16 as well as an actuator 18. The output unit 16 can include a speaker and/or a monitor in order to communicate acoustic and/or optical warning signals to the driver. The actuator can be formed by a vibration element, which is for example connected to the steering wheel and/or to motor vehicle seat components.

The motor vehicle 2 is positioned on a highway denoted with reference numeral 20. The highway 20 comprises a left lane 22, a center lane 24, and a right lane 26. The highway 20 is limited on the left side by the highway delimitation 28 and on the right side by the highway delimitation 30. The delimitations normally comprise continuous markings that are several centimeters wide. They are commonly painted white or yellow. Highway delimitations 32 and 34 are centrally positioned between the lanes 22 and 24 as well as 24 and 26. These are commonly not solid, but interrupted in order to show the driver that in this area he is permitted to change over to the neighboring lanes. The delimitations or markings 32 and 34 may be applied to the highway by familiar means, for example.

If the motor vehicle 2 leaves the lane 24 towards lane 26, the right front wheel 6 comes in contact with the center highway delimitation 34 as illustrated in FIG. 2. In this example, the running surface of the tire of the wheel 6 covers the highway delimitation 34 to a small degree of overlap 35. If the motor vehicle 2 continues to travel further toward lane 26, the wheel 6 and the highway delimitation 34 will completely overlap (see FIG. 3).

In this example, the relative position between the motor vehicle 2 and highway delimitation 34 illustrated in FIG. 2 is assigned a warning signal with a lower intensity than the situation illustrated in FIG. 3. This is described in more detail hereinafter with reference to FIG. 4. FIG. 4 includes a graph having an x-axis 36 as well as a y-axis 38. Different positions of the motor vehicle 2 relative to a highway delimitation, for example the highway delimitation 34, are assigned to the x-axis 36. Warning signals of different intensities are assigned to the y-axis 38.

The assignment is performed through a function 40. It begins with a condition 42, which corresponds to the condition that is illustrated in FIG. 2 (onset of overlap of the wheel 6 with the highway delimitation 34), for example. The intensity of the warning signal increases up to a condition 44, which corresponds to the complete overlap of the wheel 6 and highway delimitation 34, as illustrated in FIG. 3, for example. In this variation, the intensity of the warning signal increases proportionally between the conditions 42 and 44. The warning signal type can be optical and/or acoustic and/or haptic.

In this variation, the intensity of the warning signal is no longer increased after condition 44 has been achieved. It remains at a high level up to a condition 46. Condition 46 may be achieved, for example, if the front wheel 6 has completely crossed the highway delimitation 34 so that the wheel 6 is completely positioned on the highway lane 26 or if all wheels 4 through 10 have completely crossed the highway delimitation 34. In addition or in the alternative, condition 46 may be achieved if a predetermined time period has lapsed, and/or if the motor vehicle 2 has traveled a minimum distance. The intensity of the warning signal can be decreased after achieving the condition 46 until the condition 48 has been achieved.

The function 40 may be varied, for example, to extend the duration according to function 50 or to not provide a duration according to function 52 and to again decrease the intensity of the warning signal immediately after the maximum has been achieved.

It should be noted that the disclosure is not limited to the embodiment described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

What is claimed is:

1. A warning system for a motor vehicle, the warning system comprising:
a sensor system configured to sense a plurality of relative positions of the motor vehicle relative to at least one highway delimitation which is marked on a highway;
an evaluation unit coupled to the sensor system; and
at least one of an output unit and an actuator, the at least one of the output unit and the actuator being connected to the evaluation unit and being configured to output warning signals to a driver, the warning signals having at least one of different types and different intensities assigned to different relative positions of the plurality of relative positions of the motor vehicle relative to the at least one highway delimitation.

2. The warning system according to claim 1, wherein a relative position of the plurality of relative positions of the motor vehicle to be sensed includes a condition in which at least one wheel of the motor vehicle completely crosses the highway delimitation.

3. The warning system according to claim 1, wherein a relative position of the plurality of relative positions of the motor vehicle to be sensed includes a condition in which at least one wheel of the motor vehicle crosses the highway delimitation at least in sections.

4. The warning system according to claim 1, wherein the sensor system and the evaluation unit are configured to evaluate the degree of overlap of the highway delimitation and a wheel of the motor vehicle.

5. The warning system according to claim 1, wherein the plurality of relative positions includes at least a first relative position in which at least one wheel of the motor vehicle crosses the highway delimitation at least in sections and a second relative position in which at least one wheel of the motor vehicle completely crosses the highway delimitation, the first relative position being assigned a warning signal of lower intensity than the second relative position.

6. The warning system according to claim 1, wherein the plurality of relative positions includes at least a first relative position in which a wheel of the motor vehicle covers the highway delimitation with a first, lesser degree of overlap at least in sections and a second relative position in which a wheel of the motor vehicle covers the highway delimitation with a second, higher degree of overlap at least in sections, the first relative position being assigned a warning signal of lower intensity than the second relative position.

7. The warning system according to claim 1, wherein the warning signals have different intensities assigned to different relative positions, the assignment of different intensities of warning signals to different relative positions being proportional.

8. The warning system according to claim 1, wherein the plurality of relative positions includes at least a first relative position in which at least one wheel of the motor vehicle crosses the highway delimitation at least in sections and a second relative position in which at least one wheel of the motor vehicle completely crosses the highway delimitation, the first relative position being assigned a warning signal of a first type and the second relative position being assigned a warning signal of a second type.

9. The warning system according to claim 1, wherein the plurality of relative positions includes at least a first relative position in which a wheel of the motor vehicle covers the highway delimitation with a first, lesser degree of overlap at least in sections and a second relative position in which a wheel of the motor vehicle covers the highway delimitation with a second, higher degree of overlap at least in sections, the first relative position being assigned a warning signal of a first type and the second relative position being assigned a warning signal of a second type.

10. The warning system according to claim 1, wherein at least one warning signal is acoustic.

11. The warning system according to claim 1, wherein at least one warning signal is optical.

12. The warning system according to claim 1, wherein at least one warning signal is haptic.

13. A method for the operation of a warning system of a motor vehicle, the method comprising:
sensing at least one relative position of the motor vehicle relative to a highway delimitation which is marked on a highway;
assigning a warning signal to the relative position of the motor vehicle relative to the highway delimitation;
outputting the warning signal to a driver; and
diminishing the intensity of the warning signal if at least one predetermined reference condition is achieved.

14. The method according to claim 13, wherein the reference condition corresponds to the complete crossing of the highway delimitation by at least one wheel of the motor vehicle.

15. The method according to claim 13, wherein the reference condition corresponds to the complete crossing of the highway delimitation by all operational wheels of the motor vehicle.

16. The method according to claim 13, wherein the reference condition corresponds to the lapse of a time period.

17. The method according to claim 13, wherein the reference condition corresponds to a minimum traveled distance.

18. A method for the operation of a warning system of a motor vehicle, the method comprising:
sensing at least one relative position of the motor vehicle relative to a highway delimitation which is marked on a highway;
assigning a warning signal to the relative position of the motor vehicle relative to the highway delimitation;
outputting the warning signal to a driver; and
terminating the intensity of the warning signal if at least one predetermined reference condition is achieved.

19. The method according to claim 18, wherein the reference condition corresponds to the complete crossing of the highway delimitation by at least one wheel of the motor vehicle.

20. The method according to claim 18, wherein the reference condition corresponds to at least one of the lapse of a time period and a minimum traveled distance.
